(19) United States
(12) Patent Application Publication
(10) Pub. No.: US 2026/0265864 A1
(43) Pub. Date: Sep. 10, 2026

(54) SYSTEMS AND METHODS FOR COMBINED CO2 STORAGE AND METAL EXTRACTION FROM ULTRAMAFIC ROCK AND MINE TAILINGS

(71) Applicant: The Trustees of Columbia University in the City of New York, New York, NY (US)

(72) Inventors: PETER B. KELEMEN, Nyack, NY (US); JAMES A LEONG, Oxford, OH (US)

(73) Assignee: The Trustees of Columbia University in the City of New York, New York, NY (US)

(21) Appl. No.: 19/657,809

(22) Filed: Apr. 24, 2026

Related U.S. Application Data
(63) Continuation of application No. PCT/US2024/052761, filed on Oct. 24, 2024.
(60) Provisional application No. 63/545,425, filed on Oct. 24, 2023.
(60) Provisional application No. 63/613,260, filed on Dec. 21, 2023.

(51) Int. Cl. C22B 3/00; C22B 3/06; C22B 5/00; C22B 7/00

(52) U.S. Cl. CPC C22B 23/0415; C22B 3/06; C22B 5/00; C22B 7/007

(57) ABSTRACT

Nickel and cobalt-containing silicate feedstocks, e.g., ultramafic rock and mining tailings, are reacted with CO₂-rich aqueous solutions at fluid:solid ratios below 10, and in the presence of reducing agents such as 1 wt % iron sulfides (pyrite, pyrrhotite, etc.), 5 wt % scrap metallic iron and/or aluminum, etc. The silicates in the feedstocks are dissolved, CO₂ is sequestered into carbonates and graphite, and the reducing agents help prevent Ni sequestration in the carbonates and remaining silicates and avoid retention of unreacted Fe-rich sulfides in the final target reaction products. Control of the fluid:solid ratio of solution to feedstock is used to generate the desired target product. Thus, Ni and Co dissolved during carbon mineralization of silicate minerals are precipitated in newly formed Co-bearing, Ni-rich sulfides (rather than Fe-rich sulfides) and Fe—Ni alloy grains (Ni₃Fe), some carbon is precipitated as graphite, and some CO₂ in the reaction mixture is precipitated in carbonate minerals.

### CROSS-REFERENCE TO RELATED APPLICATIONS

This application is a continuation of International Patent Application No. PCT/US2024/052761, filed Oct. 24, 2024, which claims the benefit of U.S. Provisional Patent Application Nos. 63/545,425, filed Oct. 24, 2023, and 63/613,260, filed Dec. 21, 2023, which are incorporated by reference as if disclosed herein in their entireties.

### BACKGROUND

Ultramafic rocks comprise most of the Earth's upper mantle, and are composed mainly of anhydrous magnesium- and iron-bearing silicate minerals olivine and pyroxene (>18 wt % MgO, about 10 wt % FeO, <45 wt % SiO₂). Mantle rocks are locally uplifted from the mantle and exhumed on the surface by plate tectonics, and are found in numerous locations in the United States and other countries. Ultramafic rocks are also produced in the early, high temperature stages of crystallization of mantle-derived magmas, as for example in the Stillwater intrusion in Montana. At the surface, ultramafic rocks are unstable and react readily with surface fluids, forming hydrous silicates, Mg-hydroxide, and Fe-rich oxi-hydroxides, together with carbonate minerals. Oxidation of Fe²⁺ in silicates, to form alteration products with high Fe³⁺, yields highly reduced fluids, ultimately saturated in Ni₃Fe alloy (awaruite, Ni₃Fe) and even H₂ gas.

When ultramafic rocks react with CO₂-rich fluids, they can become completely “carbonated”, such that all Mg and Ca are dissolved from silicate minerals and incorporated in magnesite (MgCO₃), calcite (CaCO₃) and dolomite (CaMg(CO₃)₂), while the remaining Si forms the mineral quartz (SiO₂). CO₂-rich aqueous fluids (and hydrous CO₂-fluids) have a low initial pH, which hastens the dissolution of silicates. During this process, nickel (Ni) and cobalt (Co) that were hosted in silicate minerals, e.g., in ultramafic mine tailings, are completely redistributed. Given their abundance, reactivity, and high concentrations of divalent cations (Mg⁺², Fe⁺², and some Ca⁺²) to form solid carbonate minerals, both anhydrous and hydrated ultramafic rocks are potential feedstock for engineered carbon capture and permanent storage.

About half the Ni and Co in olivine-rich or serpentinite ore deposits is concentrated in small amounts of sulfide and/or iron (Fe)—Ni alloy minerals, which can be extracted via density and magnetic separation. The remaining half of the Ni and Co is often left in tailings, dissolved in silicate minerals at about 1000- and about 100-ppmw concentrations, respectively. About half of Ni production, with byproduct Co, comes from deposits in ultramafic rocks. Metallic Ni with byproduct Co element production, along with graphite, are classified as “critical” by the US Geological Survey given their importance to modern infrastructure, e.g., steel and superalloy, and the transition to greener energy sources, e.g., rechargeable batteries, magnets. The anticipated transition to electric vehicles, and use of renewable electricity for climate control in buildings, will require greatly expanded supplies of “critical materials” used in batteries, including nickel, cobalt, and graphite.

The potential for synergistic accelerated carbon mineralization and Ni and Co mobilization and recovery in ultramafic materials has received increased attention. Inexpensive extraction of these metals could increase ore value, and reduce mine size for a given yield. Olivine-rich and serpentinite tailings have also been considered as reservoirs for solid storage of CO₂ via carbon mineralization. Most of the proposed methods involve multi-step processes in which carbon mineralization and metal recovery are at separate stages in an engineered flow path. In most cases, divalent cations and “critical minerals” are first leached using strong acids and/or organic ligands. Leached metals are eventually converted into metal sulfides through addition of H₂S. While there is potential for combined CO₂ storage and extraction of metals from tailings, substantially all Ni (and probably Co) is reprecipitated at low concentration in carbonate minerals in fully carbonated peridotites. Since one goal of combined carbon mineralization and metal extraction is permanent, solid storage of CO₂, it is not desirable to dissolve carbonate reaction products to recover Ni.

### SUMMARY

Aspects of the present disclosure are directed to systems and methods to extract nickel (Ni) and cobalt (Co) from ultramafic rocks and mine tailings rich in magnesium silicate minerals (rocks from the Earth's mantle known as peridotite, igneous rocks rich in the mineral olivine, and hydrated equivalents of these rocks known as serpentinite) while also permanently storing carbon via formation of magnesium carbonate minerals and/or graphite. In some embodiments, these methods extract target products by contacting CO₂-rich water with ultramafic rock and mining tailings to dissolve silicates, precipitate carbonates and/or graphite, and concentrate Ni and Co in dense phases. Adding small amounts of reducing agents in low fluid:solid ratio reaction mixtures, e.g., weight ratios between about 10 and about 0.1, creates a geochemical environment favoring formation of Ni- and Co-rich sulfides or metals. Single stage methods that use inexpensive reagents to yield carbon mineralization combined with Ni, Co, and graphite extraction can be scaled to the large inventory of legacy tailings to address the growing demand for Ni, Co, and graphite in batteries and other green-tech applications while reducing the corresponding footprint of new mines.

Aspects of the present disclosure include methods of extracting products from metal-containing feedstocks including providing an amount of one or more feedstocks; providing an extraction composition fluid including a concentration of dissolved CO₂; contacting the feedstocks with an amount of the extraction composition fluid and a concentration of one or more reducing agents to form a first reaction mixture, the first reaction mixture having a fluid:solid ratio by weight of extraction composition fluid to feedstock below 10 and above 0.1; sequestering at least a portion of the dissolved CO₂ in the feedstocks; isolating a first target product from the first reaction mixture, the first target product including a concentration of Ni, Co and graphite, or combinations thereof from the feedstock; contacting the feedstocks with an amount of the extraction composition fluid and a concentration of one or more reducing agents to form at least a second reaction mixture, the second reaction mixture having a different fluid:solid ratio relative to the first reaction mixture; and isolating at least a second target product from the second reaction mixture, the second target product including a concentration of Ni, Co, graphite, or combinations thereof from the feedstock. In some embodiments, the feedstocks include ultramafic rock, ultramafic mining tailings, or combinations thereof. In some embodiments, the reducing agents include iron sulfides, metallic iron, metallic aluminum, or combinations thereof. In some embodiments, e.g., depending on reaction kinetics, the metallic iron, metallic aluminum, or combinations thereof are provided at a concentration less than about 10 wt %. In some embodiments, the iron sulfides include pyrite, pyrrhotite, or combinations thereof, and are provided at a concentration less than about 1 wt %; or combinations thereof. In some embodiments, the first target product and the second target product includes one or more sulfide compounds and/or one or more iron metal-containing alloys.

Aspects of the present disclosure are directed to a system for extracting products from metal-containing feedstocks including an extraction reactor; a source of one or more feedstocks in communication with the extraction reactor; a feedstream including a CO₂-rich aqueous extraction composition fluid in fluid communication with the extraction reactor; a source of one or more reducing agents in communication with the extraction reactor; a reaction mixture in the extraction reactor including amounts of the one or more feedstocks, the aqueous extraction composition fluid, and the one or more reducing agents; and a target product outlet stream.

### BRIEF DESCRIPTION OF THE DRAWINGS

The drawings show embodiments of the disclosed subject matter for the purpose of illustrating the invention. However, it should be understood that the present application is not limited to the precise arrangements and instrumentalities shown in the drawings, wherein:

FIG. 1 is a chart of a method of extracting products from metal-containing feedstocks according to some embodiments of the present disclosure;

FIG. 2A is a graph portraying mass-transfer thermodynamic simulations of methods of extracting products from metal-containing feedstocks according to some embodiments of the present disclosure, demonstrating the extraction of various target products (Ni₃Fe alloy—awaruite—and/or Ni-rich sulfide minerals with low Fe/Ni) at low fluid:solid ratios and in the presence of iron sulfide reducing agents at 150° C. and 100 bars CO₂ pressure;

FIG. 2B is a graph portraying mass-transfer thermodynamic simulations of methods of extracting products from metal-containing feedstocks according to some embodiments of the present disclosure, demonstrating the extraction of various target products at lowered fluid:solid ratios and in the presence of iron sulfide reducing agents and an additional CO₂ gas at 150° C. and 100 bars CO₂ pressure;

FIG. 2C is a graph portraying fluid:solid ratios at which Ni-rich sulfides can first appear using systems and methods according to some embodiments of the present disclosure with different proportions of iron sulfide reducing agents at 150° C. and 100 bars CO₂ pressure;

FIG. 2D is a graph portraying mass-transfer thermodynamic simulations of methods of extracting products from metal-containing feedstocks according to some embodiments of the present disclosure, demonstrating the extraction of various target products at lowered fluid:solid ratios and in the presence of reducing agents including iron sulfides, Fe-metal, or Al-metal at 150° C. and 100 bars CO₂ pressure;

FIG. 2E is a graph portraying fluid:solid ratios at which iron metal-containing alloys can first appear using systems and methods according to some embodiments of the present disclosure with Fe- or Al-metal reducing agents at 150° C. and 100 bars CO₂ pressure;

FIG. 2F is a graph portraying fluid:solid ratios at which target products appear according to some embodiments of the present disclosure performed at 25° C.;

FIG. 3A is a schematic representation of a system for extracting products from metal-containing feedstocks according to some embodiments of the present disclosure;

FIG. 3B is a schematic representation of a system for extracting products from metal-containing feedstocks according to some embodiments of the present disclosure;

FIG. 3C is a graph portraying target product generation with linearly decreasing fluid:solid ratios according to some embodiments of the present disclosure; and

FIG. 4 is a chart of a method of extracting products from metal-containing feedstocks according to some embodiments of the present disclosure.

### DETAILED DESCRIPTION

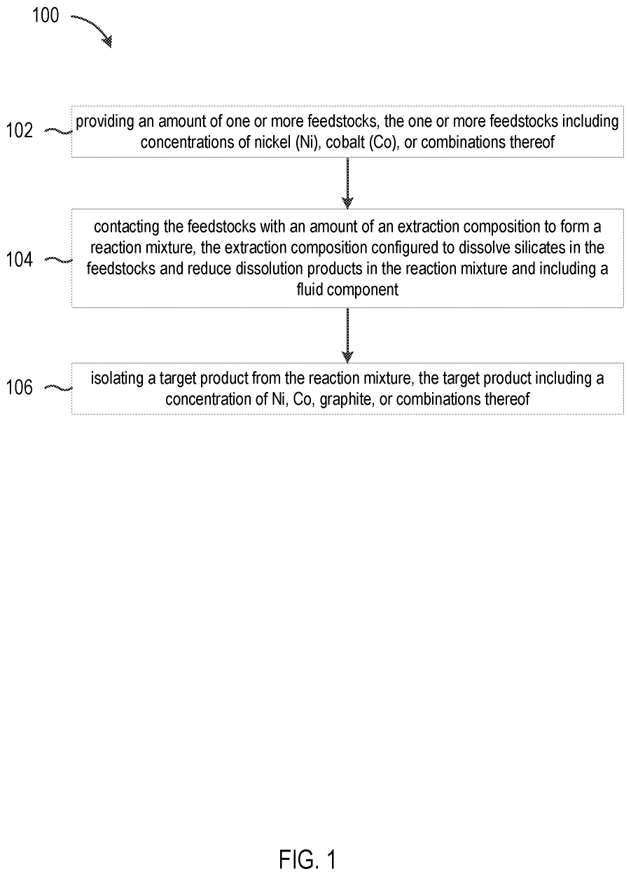

Referring now to FIG. 1, some embodiments of the present disclosure are directed to a method of extracting products from metal-containing feedstocks. In some embodiments, at 102, an amount of one or more feedstocks are provided. In some embodiments, the feedstocks include concentrations of nickel (Ni), cobalt (Co), or combinations thereof. In some embodiments, the feedstocks include iron-containing silicates. In some embodiments, at least a portion of the Ni and/or Co in the feedstocks is present in hydrous silicates, anhydrous silicates, sulfide compounds, Ni-iron alloys, Co-iron alloys, or combinations thereof. In some embodiments, the feedstocks include ultramafic rock, mining tailings, or combinations thereof.

At 104, the feedstocks are contacted with an amount of an extraction composition to form a reaction mixture. In some embodiments, the extraction composition is configured to dissolve silicates in the feedstocks. In some embodiments, the extraction composition is configured to reduce dissolution products in the reaction mixture. In some embodiments, the extraction composition is configured to dissolve silicates in the feedstocks and reduce dissolution products in the reaction mixture, as will be discussed in greater detail below.

In some embodiments, the extraction composition includes a fluid component. In some embodiments, the extraction composition fluid component includes an aqueous solution. In some embodiments, the extraction composition fluid component includes a concentration of dissolved CO₂. In some embodiments, the concentration of CO₂ in the extraction composition is at least 0.6 molal.

In some embodiments, the extraction composition includes one or more reducing agents. In some embodiments, the one or more reducing agents include a concentration of iron sulfides, metallic iron, metallic aluminum, or combinations thereof. In some embodiments, the iron sulfides include pyrite, pyrrhotite, or combinations thereof. In some embodiments, the metallic iron and/or aluminum are metallic, e.g., scrap metal, inexpensive waste materials. In some embodiments, the reaction mixture is formed by separately contacting the feedstocks with the extraction composition fluid component and the one or more reducing agents.

In some embodiments, the reaction mixture includes between about 0.1 wt % and about 10 wt % metallic iron, metallic aluminum, or combinations thereof. In some embodiments, the reaction mixture includes between about 1 wt % and about 10 wt % metallic iron, metallic aluminum, or combinations thereof. In some embodiments, the reaction mixture includes above about 1 wt % metallic iron, metallic aluminum, or combinations thereof. In some embodiments, the reaction mixture includes above about 2 wt % metallic iron, metallic aluminum, or combinations thereof. In some embodiments, the reaction mixture includes above about 3 wt % metallic iron, metallic aluminum, or combinations thereof. In some embodiments, the reaction mixture includes above about 4 wt % metallic iron, metallic aluminum, or combinations thereof. In some embodiments, the reaction mixture includes above about 5 wt % metallic iron, metallic aluminum, or combinations thereof. In some embodiments, the reaction mixture includes above about 6 wt % metallic iron, metallic aluminum, or combinations thereof. In some embodiments, the reaction mixture includes above about 7 wt % metallic iron, metallic aluminum, or combinations thereof. In some embodiments, the reaction mixture includes above about 8 wt % metallic iron, metallic aluminum, or combinations thereof. In some embodiments, the reaction mixture includes above about 9 wt % metallic iron, metallic aluminum, or combinations thereof. In some embodiments, the reaction mixture includes about 10 wt % metallic iron, metallic aluminum, or combinations thereof. In some embodiments, the reaction mixture includes less than about 10 wt % metallic iron, metallic aluminum, or combinations thereof. In some embodiments, the reaction mixture includes about 5 wt % metallic iron, metallic aluminum, or combinations thereof. In some embodiments, the reaction mixture includes less than about 5 wt % iron sulfides. In some embodiments, the reaction mixture includes less than about 4 wt % iron sulfides. In some embodiments, the reaction mixture includes less than about 3 wt % iron sulfides. In some embodiments, the reaction mixture includes less than about 2 wt % iron sulfides. In some embodiments, the reaction mixture includes less than about 1 wt % iron sulfides. In some embodiments, the reaction mixture includes less than about 0.5 wt % iron sulfides. In some embodiments, the reaction mixture includes less than about 0.1 wt % iron sulfides.

In some embodiments, the reaction mixture has a mass ratio of extraction composition fluid component to feedstock configured to sequester CO₂ via carbon mineralization while extracting target products that include concentrations of Ni and Co from the feedstocks, as will be discussed in greater detail below. As used herein, the term “fluid:solid ratio” refers to the weight ratio of “extraction composition fluid” and/or “extraction composition fluid component” to feedstock in the reaction mixture. In some embodiments, the fluid:solid ratio is below 10. In some embodiments, the fluid:solid ratio is below 9. In some embodiments, the fluid:solid ratio is below 8. In some embodiments, the fluid:solid ratio is below 7. In some embodiments, the fluid:solid ratio is below 6. In some embodiments, the fluid:solid ratio is below 5. In some embodiments, the fluid:solid ratio is below 4. In some embodiments, the fluid:solid ratio is below 3. In some embodiments, the fluid:solid ratio is below 2. In some embodiments, the fluid:solid ratio is below 1. In some embodiments, the fluid:solid ratio is below 0.5. In some embodiments, the fluid:solid ratio is between 10 and 0.1. In some embodiments, the fluid:solid ratio is between 9 and 0.1. In some embodiments, the fluid:solid ratio is between 8 and 0.1. In some embodiments, the fluid:solid ratio is between 7 and 0.1. In some embodiments, the fluid:solid ratio is between 6 and 0.1. In some embodiments, the fluid:solid ratio is between 5 and 0.1. In some embodiments, the fluid:solid ratio is between 4 and 0.1. In some embodiments, the fluid:solid ratio is between 3 and 0.1. In some embodiments, the fluid:solid ratio is between 2 and 0.1. In some embodiments, the fluid:solid ratio is between 1 and 0.1. In some embodiments, the fluid:solid ratio is between 0.5 and 0.1.

In some embodiments, feedstocks are contacted at 104 with an amount of an extraction composition to form a reaction mixture at a predetermined temperature. In some embodiments, contacting 104 occurs at a temperature between about 25° C. and about 200° C. In some embodiments, contacting 104 occurs at about ambient temperature. In some embodiments, contacting 104 occurs at a temperature between about 100° C. and about 200° C. In some embodiments, contacting 104 occurs at a temperature between about 100° C. and about 150° C. In some embodiments, contacting 104 occurs at a temperature between about 150° C. and about 200° C. In some embodiments, contacting 104 occurs at about 150° C. In some embodiments, contacting occurs at about 185° C., e.g., to advantageously benefit a rate of olivine carbonation in the feedstock.

In some embodiments, feedstocks are contacted at 104 with an amount of an extraction composition to form a reaction mixture, as well as with an additional source of CO₂ gas. The CO₂ gas-containing stream is introduced in order to sequester additional CO₂ in the reacted feedstock via additional carbon mineralization. In some embodiments, the additional source of CO₂ gas is a CO₂ gas-containing stream. In some embodiments, the additional source of CO₂ gas includes any suitable gaseous medium containing CO₂, the sequestration of which is desired, e.g., ambient air, industrial effluent, etc., or combinations thereof. In some embodiments, the CO₂ gas-containing stream is contacted with the feedstocks, the extraction composition, the reaction mixture, or combinations thereof. In some embodiments, the CO₂ gas is contacted at 104 at a pressure above about 10 bar, 20 bar, 30 bar, 40 bar, 50 bar, 60 bar, 70 bar, 80 bar, 90 bar, or 100 bar. In some embodiments, the CO₂ gas is contacted at 104 at a pressure between about 70 bar and about 100 bar. In some embodiments, the CO₂ gas is contacted at 104 at a pressure of about 100 bar.

Still referring to FIG. 1, at 106, a target product is isolated from the reaction mixture. As discussed above, in some embodiments, the target product includes a concentration of Ni, Co, graphite, or combinations thereof. In some embodiments, the target product includes a concentration of Ni, Co, graphite, or combinations thereof including Ni, Co, and/or graphite previously included in the feedstock. In some embodiments, the target product includes sulfide compounds, iron metal-containing alloy, or combinations thereof.

Exemplary embodiments of the present disclosure add one or more reducing agents such as pyrite (FeS₂), pyrrhotite (FeS), metallic iron (Fe⁰) and/or metallic aluminum (Al⁰) as solid reactants and/or as a suspension, e.g., a fine-grained solid suspension, in CO₂-rich fluids injected into Ni- and Co-containing feedstocks, e.g., ultramafic rocks, mining tailings, etc., where the interaction between the solids and fluids render the fluid increasingly alkaline and reduced. Alkaline, reduced fluids are useful for carbon mineralization, Ni and Co sulfidation, iron-nickel (Fe—Ni) alloy formation, and formation of graphite. Introduction of sulfide minerals ensures controlled availability of sulfur, and addition of reduced sulfides, metallic Fe⁰ and/or metallic Al⁰ maintains a low partial pressure of oxygen. During dissolution of the feedstocks, these reducing agents help prevent Ni sequestration in carbonates and remaining silicates, and avoids retention of unreacted Fe-rich sulfides in the final product. These factors facilitate partitioning of Ni and Co into “reduced” sulfide minerals and FeNi alloys. Thus, Ni and Co dissolved during carbon mineralization of silicate minerals are precipitated in newly formed Co-bearing, Ni-rich sulfides (rather than Fe-rich sulfides) and Ni₃Fe alloy grains, some C is precipitated as graphite, and the remaining CO₂ in the fluids can be precipitated in carbonate minerals.

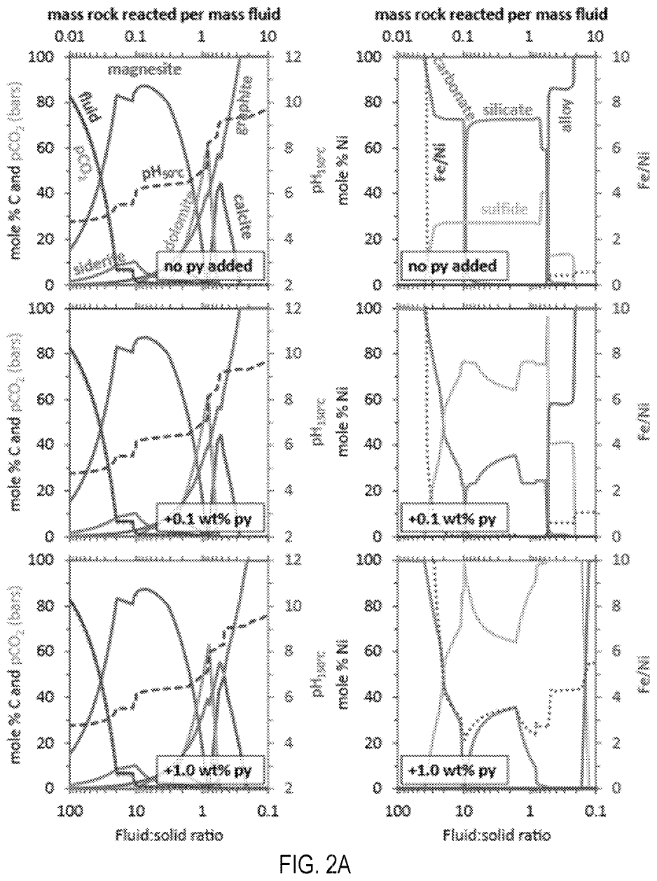

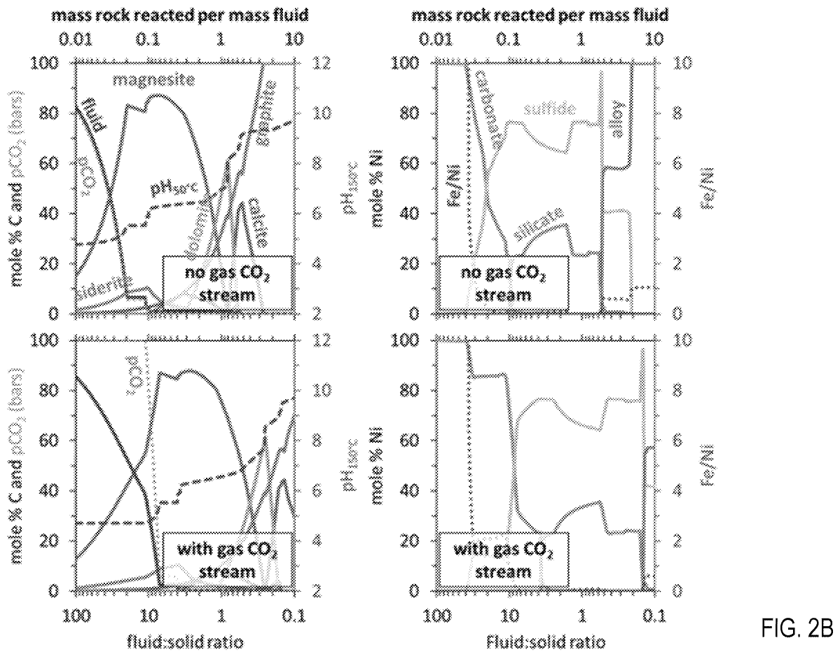

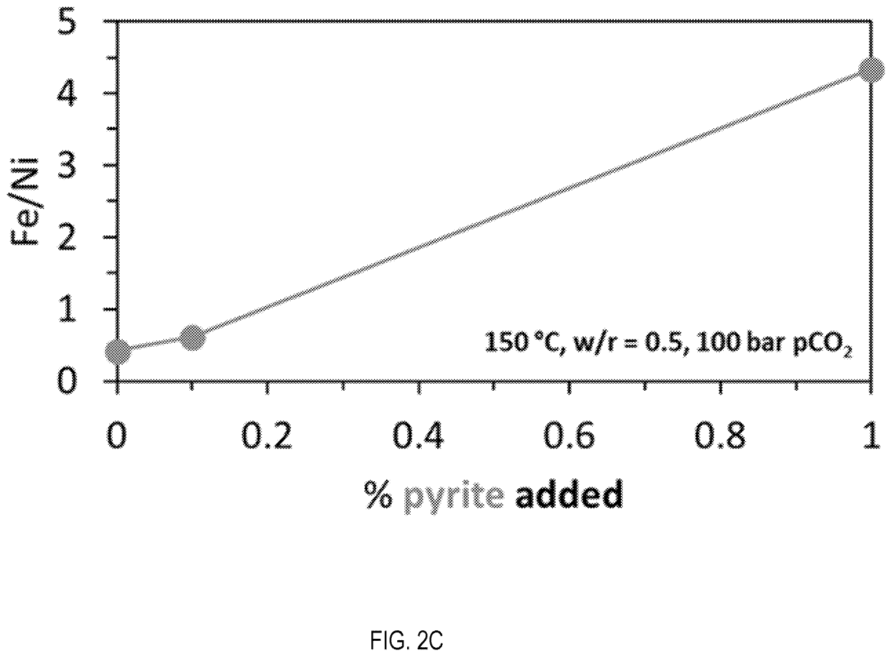

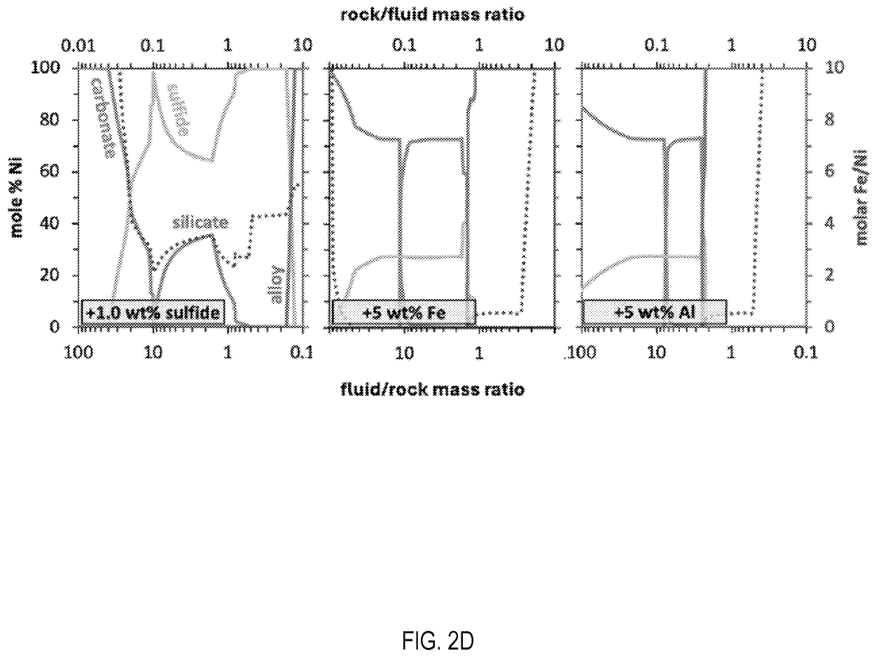

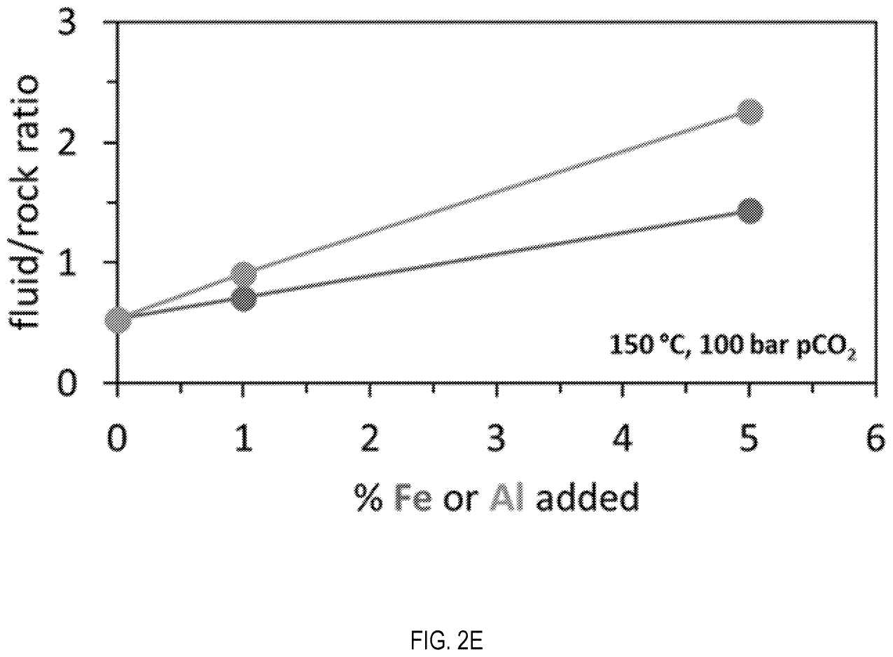

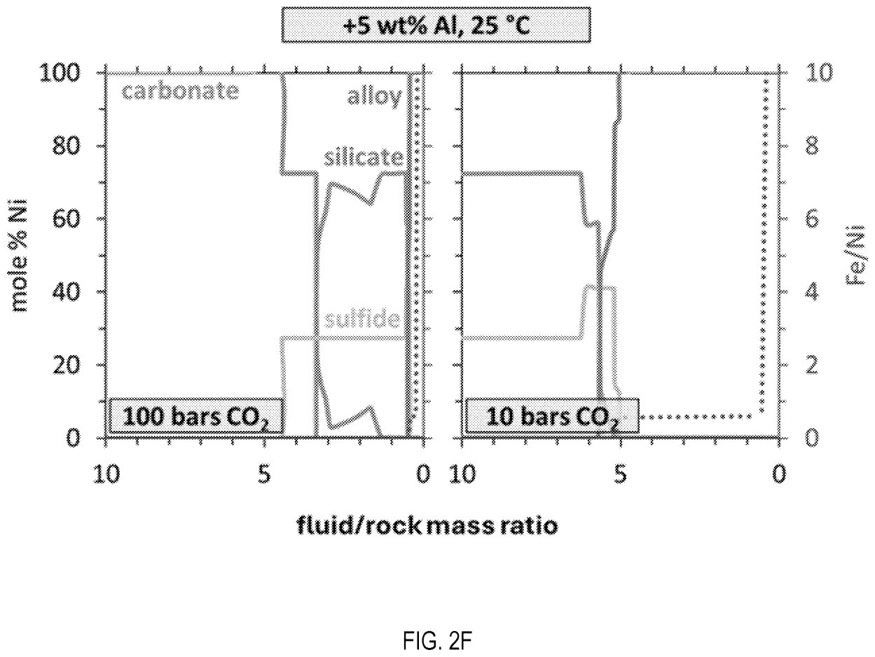

Referring now to FIG. 2A, equilibrium mineralization products can be predicted by mass-transfer thermodynamic simulations. Simulations of a method for extracting products from ultramafic material with an aqueous fluid having 0.6 molal CO₂ at 150° C. consistent with embodiments of the present disclosure were performed. At high fluid:solid ratios, e.g., (>50), most of the carbon remained in solution. As more ultramafic material reacted at fluid:solid ratios from 50 to 2, more carbon was precipitated in minerals, mostly magnesite (MgCO₃) and minor siderite (FeCO₃). As carbon was incorporated into minerals, the concentration of remaining dissolved CO₂ in the fluid decreased. Once dissolved carbon was depleted, the pH jumped to higher values promoting carbonate precipitation. In this exemplary embodiment, all carbon dissolved in the initial reaction mixture was completely sequestered at a fluid:solid ratio of about 10. As the fluid became more alkaline and enriched in Ca, some of the magnesite (MgCO₃) and siderite (FeCO₃) reacted to form dolomite (CaMg)(CO₃)₂ and calcite (CaCO₃). Aside from increasing pH, the fluid also became more reduced as the fluid:solid ratio decreased and dissolved H₂ was generated by oxidation of ferrous iron in the ultramafic material to form ferric-iron-bearing mineral products. Reduction of some of the precipitated carbonates to graphite occurred under these reduced conditions. At fluid:solid ratios <0.5, this yielded significant amounts of graphite.

The distribution of Ni among mineral products, in carbonates, silicates, sulfides, and Ni₃Fe alloys, is also shown. At high fluid:solid ratios, Ni was mostly dissolved in carbonate minerals, with minor amounts Ni-bearing, Fe-sulfides. However, in methods consistent with embodiments of the present disclosure, sequestration of Ni into sulfides was enhanced at lower fluid:solid ratios, when fluids were depleted in dissolved carbon and oxygen. Adding 0.1 to 1 wt % pyrite increased bulk sulfur concentration by one to two orders of magnitude, and thereby provided benefits to metal recovery. First, it inhibited sequestration of Ni in remaining silicates at fluid:solid ratios <10. 75 to 100% Ni conversion was achievable in embodiments of the present disclosure, e.g., by adding 0.1 wt % sulfide minerals. Secondly, molar Fe:Ni ratios in product sulfides were very low (1:1 to 0:1). Third, as a result, e.g., of limited sulfur availability together with decreasing pO₂, Ni₃Fe alloys formed at fluid:solid ratios <0.5. Small amounts of added sulfide, e.g., <1 wt % of Fe sulfide in an ultramafic material, can attain pH2S and pH2 conditions that favor formation of Ni sulfides relative to more soluble Fe sulfides, and can allow formation of Ni₃Fe alloys at lower fluid:solid ratios. Methods consistent with embodiments of the present disclosure also offer flexibility in targeting desired target products. For instance, if Ni sulfide is preferred over Ni₃Fe alloy, preloading the ultramafic material with 1 wt % pyrite, instead of 0.1 wt %, can suppress alloy formation and yield Ni-rich sulfides over a wider range of fluid:solid ratios. In the examples shown in FIG. 2A, the solid reactant was a serpentinized peridotite containing 0.2 wt % Ni. Thus, 1 metric ton of feedstock can yield 1 to 2 kg of highly concentrated Ni in sulfides and/or Ni₃Fe alloys via embodiments of the present disclosure.

Referring now to FIGS. 2B-2C, thermodynamic simulations of exemplary embodiments of the present disclosure demonstrate the use of additional CO₂ to provide favorable Ni concentration outcomes. The top panels in FIG. 2B depict reaction of ultramafic materials with 0.1 wt % Fe sulfide added, with a carbon-bearing aqueous solution (0.6 molal C, similar to the middle panels in FIG. 2A). In contrast, the bottom panels in FIG. 2B depict reaction with the same feedstock, but with a constant pCO₂ of 100 bars, up to a fluid:solid ratio of 10. Overall, Ni-rich products are similar to those in FIG. 2A, and can first appear in higher fluid:solid ratios with concentrations of iron sulfide reducing agents (see FIG. 2C). However, Ni sulfides are favored over Ni₃Fe alloys when an initially high pCO₂ is imposed.

At the low fluid:solid ratios consistent with embodiments of the present disclosure, much of the Mg is still in silicate minerals (mostly serpentine). Thus, after target products are extracted using the systems and methods of the present disclosure, waste materials can be used for subsequent carbon mineralization. In further embodiments, a switch back into a continuous stream CO₂, e.g., supercritical CO₂ and/or CO₂-rich gas, in the same reactor following the abovementioned steps can allow for streamlined carbon mineralization processes while preserving earlier precipitated Ni sulfides and Ni₃Fe alloys for later extraction.

Referring now to FIGS. 2D-2E, thermodynamic simulations similar to those described above were also conducted at various other reaction conditions including metallic iron and aluminum rather than Fe sulfide, as reducing agents. Embodiments of the present disclosure advantageously identified that upon addition of metal to the reaction mixture, e.g., scrap iron and/or aluminum, target products such as iron metal-containing alloy (and graphite) start to appear at higher fluid:solid ratios compared to those using Fe sulfide reducing agents, and continue to evolve over wider ranges of fluid:solid ratios (see FIG. 2E). Referring also to Table 1, the results were similar to those shown in FIG. 2A, namely that more Ni₃Fe alloy was formed when metallic Fe⁰ or metallic Al⁰ is added, occurring “earlier” in the reaction progress and at higher fluid:solid ratios. With 1 wt % added Fe sulfide, abundant Ni-rich sulfide formed, alloy formed late, at relatively low fluid:rock ratios <0.5, and Fe:Ni in combined sulfide and alloy target products was <7. With 5 wt % added Fe or Al metal, NiFe alloy formed at fluid:solid ratios of about 1 or 2, sulfide no longer formed, and Fe:Ni was <1 until Fe metal formed at low fluid:solid ratios.

TABLE 1
150 C., 100 bar CO₂

| | W/R* | W/R** | ΔW/R |
|---|---|---|---|
| % Fe added | | | |
| 0 | 0.53 | | 0.53 |
| 1 | 0.71 | | 0.71 |
| 5 | 1.43 | 0.26 | 1.17 |
| % Al added | | | |
| 0 | 0.53 | | 0.53 |
| 1 | 0.91 | 0.13 | 0.78 |
| 5 | 2.26 | 0.47 | 1.79 |

Calculated ranges in fluid:solid ratios from when awaruite (Ni₃Fe) becomes the dominant Ni hosting phase until when metallic Fe becomes stable.
*W/R when awaruite becomes dominant Ni-hosting phase.
**W/R when metallic Fe is stable and Fe/Ni ratios in reaction products rise abruptly. No values mean metallic Fe does not form at minimal w/r of ~0.1

Referring now to FIG. 2F, exemplary embodiments of the present disclosure were performed to identify the proportion of carbon in target products at 25° C., with the idea of developing methods that can be performed outside of a high temperature, high pressure reactor. CO₂ solubility increases with decreasing temperature, so that the CO₂ contents of 25° C. fluids are higher, at a given CO₂ pressure, than the CO₂ contents of fluids at higher temperature and the same CO₂ pressure. In the results shown in FIG. 2F, graphite and alloy products form at fluid:solid ratios from about 5.5 to 0.3 at lower partial pressures of CO₂, while increased pressure of CO₂ suppresses alloy and graphite formation, e.g., by stabilizing carbonate minerals and holding the oxygen partial pressure at a higher value.

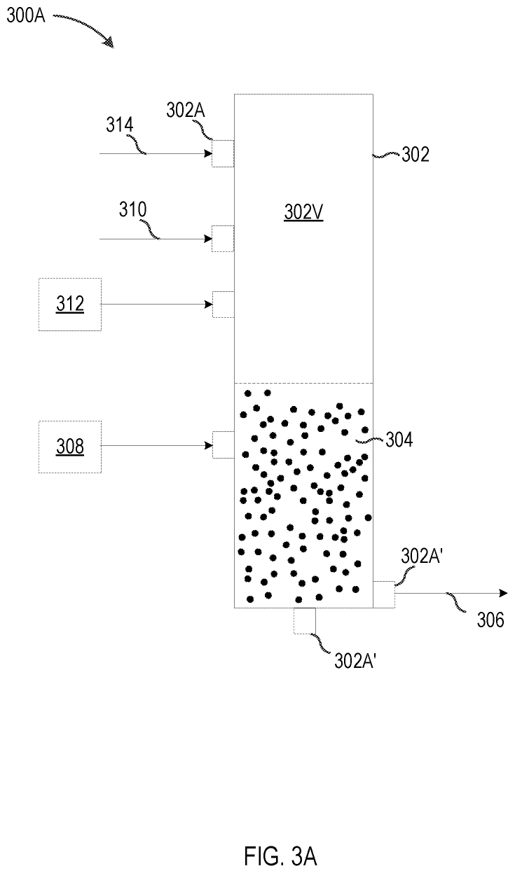

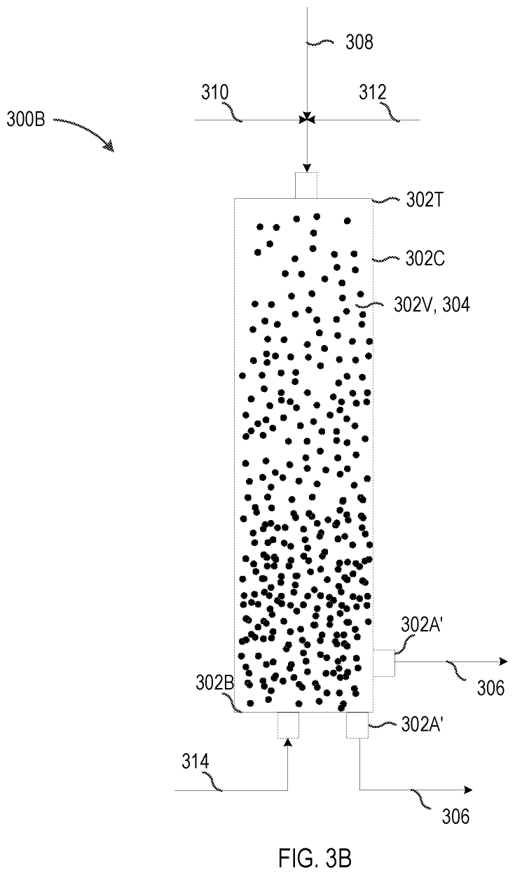

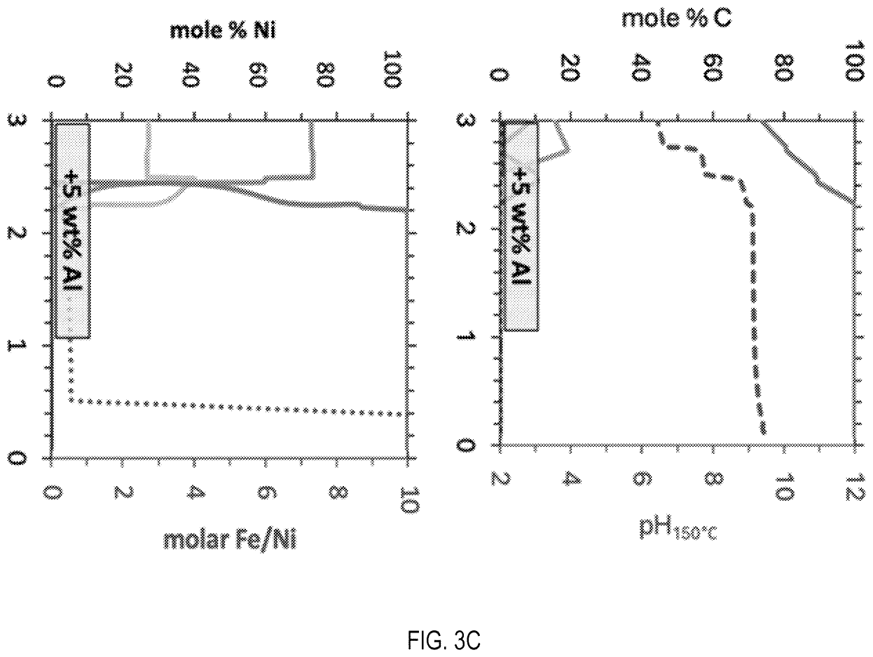

Referring now to FIG. 3A, some embodiments of the present disclosure are directed to a system 300A for extracting products from metal-containing feedstocks. In some embodiments, system 300A includes an extraction reactor 302. In some embodiments, extraction reactor 302 includes an interior volume 302V to retain a reaction mixture 304. In some embodiments, extraction reactor 302 includes one or more inlets/outlets 302A/302A′ to add reactants to volume 302V and/or reaction mixture 304, withdraw target product outlet stream 306 from volume 302V and/or reaction mixture 304.

In some embodiments, extraction reactor 302 is in communication with a source 308 of one or more feedstocks. As discussed above, in some embodiments, the feedstocks include ultramafic rock, mining tailings, or combinations thereof, including concentrations of Ni, Co, or combinations thereof. In some embodiments, extraction reactor 302 is in fluid communication with a feedstream 310 including an extraction composition fluid. As discussed above, in some embodiments, the extraction composition fluid is an aqueous solution. In some embodiments, the extraction composition fluid includes a concentration of dissolved CO₂. In some embodiments, the concentration of CO₂ in the extraction composition is at least 0.6 molal.

In some embodiments, extraction reactor 302 is in communication with a source 312 of one or more reducing agents. As discussed above, in some embodiments, the reducing agents include iron sulfides, metallic iron, metallic aluminum, or combinations thereof. In some embodiments, the one or more reducing agents include a concentration of iron sulfides, metallic iron, metallic aluminum, or combinations thereof. In some embodiments, the iron sulfides include pyrite, pyrrhotite, or combinations thereof. In some embodiments, system 300A includes a feedstream 314 of additional CO₂ gas. As discussed above, in some embodiments, amounts of feedstock from source 308, extraction composition fluid from feedstream 310, reducing agents from source 312, and/or can be combined in reaction mixture 302, or first combined prior to addition to the reaction mixture, e.g., a suspension of reducing agent in extraction composition fluid, contacting a CO₂ gas stream with the extraction composition fluid, etc.

Still referring to FIG. 3A, as discussed above, reaction mixture 304 includes amounts of feedstock from source 308, extraction composition fluid from feedstream 310, reducing agents from source 312, or combinations thereof. In some embodiments, reaction mixture 304 is maintained at a predetermined elevated temperature and pressure as discussed above, e.g., the temperature and pressure of volume 302V is controlled. In some embodiments, reaction mixture 304 includes between about 0.1 wt % and about 10 wt % metallic iron, metallic aluminum, or combinations thereof. In some embodiments, reaction mixture 304 includes between about 1 wt % and about 10 wt % metallic iron, metallic aluminum, or combinations thereof. In some embodiments, reaction mixture 304 includes above about 1 wt % metallic iron, metallic aluminum, or combinations thereof. In some embodiments, reaction mixture 304 includes above about 2 wt % metallic iron, metallic aluminum, or combinations thereof. In some embodiments, reaction mixture 304 includes above about 3 wt % metallic iron, metallic aluminum, or combinations thereof. In some embodiments, reaction mixture 304 includes above about 4 wt % metallic iron, metallic aluminum, or combinations thereof. In some embodiments, reaction mixture 304 includes above about 5 wt % metallic iron, metallic aluminum, or combinations thereof. In some embodiments, reaction mixture 304 includes above about 6 wt % metallic iron, metallic aluminum, or combinations thereof. In some embodiments, reaction mixture 304 includes above about 7 wt % metallic iron, metallic aluminum, or combinations thereof. In some embodiments, reaction mixture 304 includes above about 8 wt % metallic iron, metallic aluminum, or combinations thereof. In some embodiments, reaction mixture 304 includes above about 9 wt % metallic iron, metallic aluminum, or combinations thereof. In some embodiments, reaction mixture 304 includes about 10 wt % metallic iron, metallic aluminum, or combinations thereof. In some embodiments, reaction mixture 304 includes less than about 10 wt % metallic iron, metallic aluminum, or combinations thereof. In some embodiments, reaction mixture 304 includes about 5 wt % metallic iron, metallic aluminum, or combinations thereof. In some embodiments, reaction mixture 304 includes less than about 5 wt % iron sulfides. In some embodiments, the reaction mixture 304 includes less than about 4 wt % iron sulfides. In some embodiments, the reaction mixture 304 includes less than about 3 wt % iron sulfides. In some embodiments, the reaction mixture 304 includes less than about 2 wt % iron sulfides. In some embodiments, the reaction mixture 304 includes less than about 1 wt % iron sulfides. In some embodiments, the reaction mixture 304 includes less than about 0.5 wt % iron sulfides. In some embodiments, the reaction mixture 304 includes less than about 0.1 wt % iron sulfides. In some embodiments, the fluid:solid weight ratio of extraction composition fluid to feedstock in reaction mixture 304 is below 10. In some embodiments, the fluid:solid ratio in reaction mixture 304 is below 9. In some embodiments, the fluid:solid in ratio reaction mixture 304 is below 8. In some embodiments, the fluid:solid in ratio reaction mixture 304 is below 7. In some embodiments, the fluid:solid in ratio reaction mixture 304 is below 6. In some embodiments, the fluid:solid in ratio reaction mixture 304 is below 5. In some embodiments, the fluid:solid ratio in reaction mixture 304 is below 4. In some embodiments, the fluid:solid ratio in reaction mixture 304 is below 3. In some embodiments, the fluid:solid ratio in reaction mixture 304 is below 2. In some embodiments, the fluid:solid ratio in reaction mixture 304 is below 1. In some embodiments, the fluid:solid ratio in reaction mixture 304 is below 0.5. In some embodiments, the fluid:solid ratio in reaction mixture 304 is between 10 and 0.1. In some embodiments, the fluid:solid ratio in reaction mixture 304 is between 9 and 0.1. In some embodiments, the fluid:solid ratio in reaction mixture 304 is between 8 and 0.1. In some embodiments, the fluid:solid ratio in reaction mixture 304 is between 7 and 0.1. In some embodiments, the fluid:solid ratio in reaction mixture 304 is between 6 and 0.1. In some embodiments, the fluid:solid ratio in reaction mixture 304 is between 5 and 0.1. In some embodiments, the fluid:solid ratio in reaction mixture 304 is between 4 and 0.1. In some embodiments, the fluid:solid ratio in reaction mixture 304 is between 3 and 0.1. In some embodiments, the fluid:solid ratio in reaction mixture 304 is between 2 and 0.1. In some embodiments, the fluid:solid ratio in reaction mixture 304 is between 1 and 0.1. In some embodiments, the fluid:solid ratio in reaction mixture 304 is between 0.5 and 0.1.

In some embodiments, target product outlet stream 306 includes a concentration of Ni, Co, graphite, or combinations thereof from the feedstock. In some embodiments, target product outlet stream 306 includes one or more target products including concentrations of Ni, Co, graphite, or combinations thereof. In some embodiments, the target product includes sulfide compounds, iron metal-containing alloy, graphite, or combinations thereof. In some embodiments, reacted feedstock from reaction mixture 304 can also be withdrawn from extraction reactor 302, e.g., via one or more outlets 302A′. In some embodiments, system 300A is operated as a batch and/or semi-batch reactor.

In some embodiments, system 300A is operated continuously, semi-continuously, or combinations thereof. Some embodiments of system 300A operated continuously and/or semi-continuously utilize a column such as in system 300B show in FIG. 3B, allowing for continuous throughput at lower energy costs compared to a reactor operated at elevated temperature and pressure. In these embodiments, reactants can be added to reaction mixture 304 and products withdrawn from extraction reactor 302 in a continuous and/or semi-continuous manner. In some embodiments, rates of reactant addition, e.g., extraction composition fluid, feedstock, etc., are varied at a time (t) to control the fluid:solid ratio of reaction mixture 304, resulting in corresponding control over the target product withdrawn from extraction reactor 302 at a later time (tₙ). In some embodiments, rates of reactant addition are varied gradually to form a varied elution profile of target products, i.e., the composition of reaction mixture 304 is varied with time via adjustments to the reactant addition rates, such that the composition of target product outlet stream 306 varies similarly with time.

Still referring to FIG. 3B, in some embodiments, feedstocks, e.g., from source 308, and reducing agents, e.g., from source 312, are added to a top 302T of extraction reactor 302, e.g., column 302C from the figure. Volume 302V includes an amount of extraction composition fluid, e.g., from feedstream 310. In some embodiments, feedstream 314 of additional CO₂ gas is added from the base 302B of column 302C. In some embodiments, the height of column 302C is above about 10 m, 20 m, 30 m, 40 m, 50 m, 60 m, 70 m, 80 m, 90 m, or 100 m. In some embodiments, the height of column 302C is about 100 m.

Without wishing to be bound by theory, the height of column 302C controls the partial pressure of the water as it dissolves CO₂ from gas at base 302B. Consistent with the embodiments described above, increasing CO₂ can reduce the fluid:solid ratio at which iron metal-containing alloy first appears, while decreasing CO₂ can limit reaction rates and overall carbon storage. In one embodiment, a 100 m column 302C can be used, yielding about 10 bars of water pressure near base 302B. As the fluid descends through the column, the integrated fluid:solid ratio declines. Again without wishing to be bound by theory, the fluid:solid ratio varies linearly with depth. The highly reducing conditions for alloy and/or graphite formation occur near base 302B of the column at lower integrated fluid:solid ratios. At that condition, target product outlet streams 306 can be removed, and column 302C replenished by addition of new reactants at top 302T of the process column. Compositions of product outlet streams 306 with linearly decreasing fluid:solid ratios, e.g., as produced by columns 302C consistent with embodiments of the present disclosure, are demonstrated in FIG. 3C.

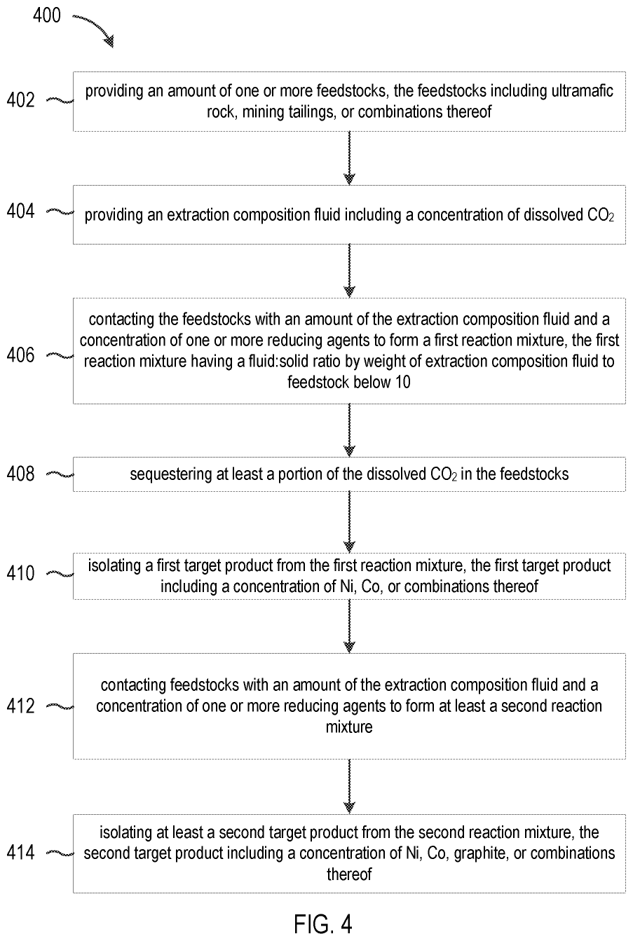

Referring now to FIG. 4, some embodiments of the present disclosure are directed to a method 400 of extracting products from metal-containing feedstocks. In some embodiments, at 402, an amount of one or more feedstocks are provided. As discussed above, in some embodiments, the feedstocks include ultramafic rock, mining tailings, or combinations thereof, including concentrations of Ni, Co, or combinations thereof. At 404, an extraction composition fluid including a concentration of dissolved CO₂ is provided. As discussed above, in some embodiments, the extraction composition fluid is an aqueous solution. In some embodiments, the concentration of CO₂ in the extraction composition is at least 0.6 molal. In some embodiments, a CO₂ gas-containing stream is contacted with the extraction composition fluid to dissolve additional CO₂ in the extraction composition fluid.

Still referring to FIG. 4, in some embodiments, at 406, the feedstocks are contacted with an amount of the extraction composition fluid and a concentration of one or more reducing agents to form a first reaction mixture. In some embodiments, the one or more reducing agents include a concentration of iron sulfides, metallic iron, metallic aluminum, or combinations thereof. In some embodiments, the first reaction mixture includes between about 0.1 wt % and about 10 wt % metallic iron, metallic aluminum, or combinations thereof. In some embodiments, the first reaction mixture includes between about 1 wt % and about 10 wt % metallic iron, metallic aluminum, or combinations thereof. In some embodiments, the first reaction mixture includes above about 1 wt % metallic iron, metallic aluminum, or combinations thereof. In some embodiments, the first reaction mixture includes above about 2 wt % metallic iron, metallic aluminum, or combinations thereof. In some embodiments, the first reaction mixture includes above about 3 wt % metallic iron, metallic aluminum, or combinations thereof. In some embodiments, the first reaction mixture includes above about 4 wt % metallic iron, metallic aluminum, or combinations thereof. In some embodiments, the first reaction mixture includes above about 5 wt % metallic iron, metallic aluminum, or combinations thereof. In some embodiments, the first reaction mixture includes above about 6 wt % metallic iron, metallic aluminum, or combinations thereof. In some embodiments, the first reaction mixture includes above about 7 wt % metallic iron, metallic aluminum, or combinations thereof. In some embodiments, the first reaction mixture includes above about 8 wt % metallic iron, metallic aluminum, or combinations thereof. In some embodiments, the first reaction mixture includes above about 9 wt % metallic iron, metallic aluminum, or combinations thereof. In some embodiments, the first reaction mixture includes about 10 wt % metallic iron, metallic aluminum, or combinations thereof. In some embodiments, the first reaction mixture includes less than about 10 wt % metallic iron, metallic aluminum, or combinations thereof. In some embodiments, the first reaction mixture includes about 5 wt % metallic iron, metallic aluminum, or combinations thereof. In some embodiments, the iron sulfides include pyrite, pyrrhotite, or combinations thereof. In some embodiments, the first reaction mixture includes less than about 5 wt % iron sulfides. In some embodiments, the first reaction mixture includes less than about 4 wt % iron sulfides. In some embodiments, the first reaction mixture includes less than about 3 wt % iron sulfides. In some embodiments, the first reaction mixture includes less than about 2 wt % iron sulfides. In some embodiments, the first reaction mixture includes less than about 1 wt % iron sulfides. In some embodiments, the first reaction mixture includes less than about 0.5 wt % iron sulfides. In some embodiments, the first reaction mixture includes less than about 0.1 wt % iron sulfides. In some embodiments, the first reaction mixture has a fluid:solid ratio by weight of extraction composition fluid to feedstock below 10. In some embodiments, the fluid:solid ratio in the first reaction mixture is between 10 and 0.1.

Referring again to FIG. 4, at 408, at least a portion of the dissolved CO₂ is sequestered in the feedstocks. At 410, a first target product is isolated from the first reaction mixture. As discussed above, in some embodiments, the first target product includes a concentration of Ni, Co, graphite, or combinations thereof. In some embodiments, the first target product one or more includes sulfide compounds, iron metal-containing alloy, graphite, or combinations thereof.

In some embodiments, at 412, feedstocks are contacted with an amount of the extraction composition fluid and a concentration of one or more reducing agents to form at least a second reaction mixture. In some embodiments, step 412 and/or subsequent steps can be repeated multiple times, i.e., to perform multiple extractions of target products from feedstocks. In some embodiments, the feedstocks contacted at 412 are new feedstocks, feedstocks from previous steps in method 400, (i.e., recycled feedstocks from steps 406-410 above), or combinations thereof. In some embodiments, the composition of the second reaction mixture is consistent with the composition of the first reaction mixture described above, however the second reaction mixture has a different fluid:solid ratio relative to the first reaction mixture. In some embodiments, the fluid:solid ratio in the second reaction mixture is between 10 and 0.1. At 414, at least a second target product is isolated from the second reaction mixture. In some embodiments, the second target product includes a concentration of Ni, Co, graphite, or combinations thereof. In some embodiments, the second target product includes one or more includes sulfide compounds, iron metal-containing alloy, graphite, or combinations thereof.

Methods and systems consistent with embodiments of the present disclosure advantageously provide rapid, quantitative extraction of Ni and Co from silicates, e.g., ultramafic rock, mining tailings, etc., into easily extractable sulfides and alloys, while also forming graphite and storing CO₂ in carbonate minerals. To achieve this, some embodiments of the present disclosure add iron sulfides, e.g., pyrite (FeS₂) and/or pyrrhotite (FeS), metallic iron, and/or metallic aluminum to solid feedstocks, and/or as a fine-grained solid suspension in CO₂-rich fluids injected into ultramafic rocks or mining tailings. As discussed above, introduction of reduced sulfide minerals helps control availability of sulfur, and addition of sulfides, metallic Fe and/or metallic Al maintains a low partial pressure of oxygen, allowing Ni and Co dissolved during carbon mineralization of silicate minerals to form sulfide and alloy grains, and separately allowing precipitation of graphite and sequestration of CO₂ in precipitated carbonates. Methods consistent with embodiments of the present disclosure can avoid drawbacks of traditional Ni and Co extraction methods, which use caustic, expensive, manufactured Na₂S, and/or toxic H₂S. In some embodiments, the methods use small amounts of added, natural sulfide minerals, to benefit the Ni content of produced sulfide minerals, and allow for formation of the Ni₃Fe alloy in addition to the Ni-rich sulfides.

Exemplary equilibrium calculations indicate that, in the course of carbon mineralization, methods consistent with embodiments of the present disclosure quantitatively remove more than 90% of the Ni and Co from silicate minerals in mining tailings, redepositing them in easily extracted sulfide minerals and metal alloys. Kinetic calculations indicate that this process can be accelerated by input of heat and/or moderate fluid pressures, at a relatively small expense compared to the value of the extracted Ni, Co and C, and the value of CO₂ storage.

In some embodiments, the methods are extendable to Ni and Co deposits hosted in mafic gabbroic rocks (ca 10 wt % MgO, 10 wt % CaO), though the kinetics of carbon mineralization and Ni and Co redistribution may be slower. In some embodiments, the methods are extended to sedimentary Cu and Co deposits, such as those in the Democratic Republic of the Congo, although those deposits have lower Mg and Ca contents, and more of the Cu, Ni and by-product Co are already contained in sulfide minerals, resulting in less Ni and Co mobilized in the course of carbon mineralization. Additionally, in some embodiments of the present disclosure, beneficial carbon-mineralization rates in ultramafic rocks are realized at about 125 to 175° C. and elevated pCO₂. However, embodiments of the present disclosure can also be extended to Ni and Co extraction from feedstocks with added sulfides and/or metallic Fe⁰ or metallic Al⁰ at ambient surface conditions, e.g., combined with methods for delivery of CO₂-rich gas, e.g., in slurry pipes or via outlets beneath tailings.

At least in part, embodiments of the present disclosure are in response to predicted demand for much larger supplies of Ni, Co and graphite (among the so-called “critical minerals”), e.g., to produce energy-dense lithium-ion batteries, most notably for electronic vehicles. Additionally, in order to mitigate greenhouse gas emissions, there is a predicted need to store CO₂ removed from flue gas and from the air, e.g., by reacting CO₂ in fluid or gas with Mg, Ca, and other cations to form solid carbonate minerals for permanent storage. Systems and methods consistent with embodiments of the present disclosure utilize inexpensive reagents to yield carbon mineralization with Ni and Co extraction, enabling scale-up for use on large inventory of legacy mine tailings to growing demand for Ni and Co, e.g., in batteries, while reducing the footprint, size, and numbers of new mines initiated to meet rising demand.

Although the invention has been described and illustrated with respect to exemplary embodiments thereof, it should be understood by those skilled in the art that the foregoing and various other changes, omissions and additions may be made therein and thereto, without parting from the spirit and scope of the present invention.

What is claimed is:

1. A method of extracting products from metal-containing feedstocks, comprising:
providing an amount of one or more feedstocks, the one or more feedstocks including concentrations of nickel (Ni), cobalt (Co), or combinations thereof;
contacting the feedstocks with an amount of an extraction composition to form a reaction mixture, the extraction composition configured to dissolve silicates in the feedstocks and reduce dissolution products in the reaction mixture and including a fluid component;
isolating a target product from the reaction mixture, the target product including a concentration of Ni, Co, graphite, or combinations thereof,
wherein the reaction mixture includes a fluid:solid ratio by weight of extraction composition fluid component to feedstock below 10,
wherein the extraction composition includes a concentration of CO₂.

2. The method according to claim 1, wherein the fluid:solid ratio by weight of extraction composition fluid component to feedstock is below about 2.

3. The method according to claim 2, wherein the fluid:solid ratio by weight of extraction composition fluid component to feedstock is above about 0.1.

4. The method according to claim 1, wherein the extraction composition includes at least about 0.6 molal CO₂.

5. The method according to claim 1, wherein the extraction composition is an aqueous solution.

6. The method according to claim 1, wherein the extraction composition includes a concentration of iron sulfides, metallic iron, metallic aluminum, or combinations thereof.

7. The method according to claim 6, wherein the reaction mixture includes between about 0.1 and about 10 wt % metallic iron, metallic aluminum, or combinations thereof.

8. The method according to claim 6, wherein the iron sulfides include pyrite, pyrrhotite, or combinations thereof.

9. The method according to claim 6, wherein the reaction mixture includes less than about 1 wt % iron sulfides.

10. The method according to claim 1, wherein the feedstock includes ultramafic rock, mining tailings, or combinations thereof.

11. The method according to claim 1, wherein contacting the feedstocks with an amount of an extraction composition to form a reaction mixture is performed at a temperature less than about 200° C.

12. The method according to claim 1, wherein contacting the feedstocks with an amount of an extraction composition to form a reaction mixture further comprises contacting the feedstocks, the extraction composition, or combinations thereof, with a CO₂ gas-containing stream.

13. The method according to claim 1, wherein the target product includes sulfide compounds, iron metal-containing alloy, graphite, or combinations thereof.

14. A method of extracting products from metal-containing feedstocks, comprising:
providing an amount of one or more feedstocks, the feedstocks including ultramafic rock, mining tailings, or combinations thereof;
providing an extraction composition fluid including a concentration of dissolved CO₂;
contacting the feedstocks with an amount of the extraction composition fluid and a concentration of one or more reducing agents to form a first reaction mixture, the first reaction mixture having a fluid:solid ratio by weight of extraction composition fluid to feedstock below 10;
sequestering at least a portion of the dissolved CO₂ in the feedstocks;
isolating a first target product from the first reaction mixture, the first target product including a concentration of Ni, Co, graphite or combinations thereof;
contacting the feedstocks with an amount of the extraction composition fluid and a concentration of one or more reducing agents to form at least a second reaction mixture, the second reaction mixture having a fluid:solid ratio by weight of extraction composition fluid to feedstock that is different than the first reaction mixture; and
isolating at least a second target product from the second reaction mixture, the second target product including a concentration of Ni, Co, or combinations thereof.

15. The method according to claim 14, wherein the extraction composition fluid is an aqueous solution, and the one or more reducing agents include a concentration of iron sulfides, metallic iron, metallic aluminum, or combinations thereof.

16. The method according to claim 15, wherein the reaction mixture includes:
metallic iron, metallic aluminum, or combinations thereof at a concentration less than about 10 wt %;
iron sulfides include pyrite, pyrrhotite, or combinations thereof at a concentration less than about 1 wt %; or
combinations thereof.

17. The method according to claim 14, wherein the first target product includes one or more sulfide compounds and the second target product includes one or more iron metal-containing alloys.

18. The method according to claim 14, further comprising contacting the feedstocks, the extraction composition fluid, or combinations thereof, with a CO₂ gas-containing stream.

19. A system for extracting products from metal-containing feedstocks, the system comprising:
an extraction reactor;
a source of one or more feedstocks in communication with the extraction reactor, the feedstocks including ultramafic rock, mining tailings, or combinations thereof;
a feedstream including an aqueous extraction composition fluid in fluid communication with the extraction reactor, the aqueous extraction composition fluid including a concentration of dissolved CO₂;
a source of one or more reducing agents in communication with the extraction reactor, the reducing agents including iron sulfides, metallic iron, metallic aluminum, or combinations thereof;
a reaction mixture in the extraction reactor, the reaction mixture including amounts of the one or more feedstocks, the aqueous extraction composition fluid; and the one or more reducing agents; and
a target product outlet stream, the target product including a concentration of Ni, Co, graphite or combinations thereof,
wherein the reaction mixture includes:
a fluid:solid ratio by weight of aqueous extraction composition fluid to feedstock below 10, and
metallic iron, metallic aluminum, or combinations thereof at a concentration less than about 10 wt %; iron sulfides including pyrite, pyrrhotite, or combinations thereof at a concentration less than about 1 wt %; or combinations thereof,
wherein the target product includes sulfide compounds, iron metal-containing alloy, graphite, or combinations thereof.

20. The method according to claim 19, wherein contacting the feedstocks with an amount of an extraction composition to form a reaction mixture is performed at about ambient temperature.
